(19) United States
(12) Patent Application Publication
(10) Pub. No.: US 2026/0078951 A1
(43) Pub. Date: Mar. 19, 2026

(54) PORTABLE TRAVEL CLOTHING DRYING DEVICE

(71) Applicant: Pak Hei Wong, Dongguan (CN)

(72) Inventor: Pak Hei Wong, Dongguan (CN)

(21) Appl. No.: 19/331,991

(22) Filed: Sep. 17, 2025

(30) Foreign Application Priority Data
Sep. 19, 2024 (CN) 202422287786.1

(51) Int. Cl. F26B 9/10

(52) U.S. Cl. CPC F26B 9/10

(57) ABSTRACT

A portable travel clothing drying device includes a drying portion having a drying surface, the drying portion is provided with a cavity or an airflow channel to facilitate circulation and discharge of airflow. Air outlets are formed on the drying surface and are in fluid communication with the airflow channel. Through rational design of positions and numbers of the airflow channel and the air outlets, a user can adjust an airflow volume according to actual requirements to achieve efficient drying. The device is capable of cooperating with a blower during use, allowing the clothing to be laid flat on a drying surface for direct drying. When not in use, the device can be easily folded or rolled for storage, significantly improving portability and space efficiency. Furthermore, the device enables simultaneous drying of a plurality of garments, accommodating various travel scenarios and having significant practical application value.

### CROSS-REFERENCE TO RELATED APPLICATIONS

This application claims the benefit of priority to Chinese Utility Model Application No. 202422287786.1, filed Sep. 19, 2024.

### TECHNICAL FIELD

The present disclosure relates to the field of travel articles, and in particular to a portable travel clothing drying device.

### BACKGROUND

Existing portable clothing drying devices are widely used in travel and outdoor activities. In particular, drying methods in combination with a hair dryer are highly favored by users due to their convenience and popularity. These devices are usually connected to a hair dryer to introduce hot air into an inflatable body, forming a structure similar to that of a “drying column. ” Clothes are hung inside the devices and dried by the flow of hot air. The main advantage of this design is that it does not require a separate heating element, and can dry the clothes using a common heat source, such as a hair dryer, thus enabling the clothing to be dried at relatively low cost. The devices are simple to operate and easy to use.

However, existing inflatable drying devices have exposed several obvious shortcomings in practical use. First, these devices require a relatively large space to operate. Once inflated, sufficient vertical height and lateral space are needed for the clothes to hang freely. In confined environments (such as hotel bathrooms or small tents), this space requirement significantly limits the usability of the devices. Especially during travel, users may find it difficult to identify suitable hanging points or sufficient space to unfold the device, greatly reducing convenience.

Second, the capacity of existing inflatable designs is limited, generally accommodating only a single garment for drying at a time. Drying efficiency is relatively low, particularly when multiple garments need to be dried. In such cases, the users have to dry the garments in multiple batches, which is both time-consuming and inconvenient. In addition, since the airflow design inside the device is not sufficiently refined, airflow distribution tends to be uneven. This often results in poor drying results, specifically, some regions of the garment are overdried, while other regions remain damp. The uneven airflow compromises overall drying performance and prolongs the users'waiting time.

More importantly, although inflatable designs provide a certain degree of functionality when in use, they present significant limitations in storage and portability. These devices cannot be fully compressed when not in use, resulting in a relatively large storage space. Furthermore, the folding and unfolding process is cumbersome. As a result, they occupy valuable luggage space during travel and limit portability and flexibility. For modern travelers who value lightweight and efficiency, this complicated storage process does not meet their daily travel needs.

The core cause of these problems lies in the structural limitations of existing inflatable designs and the lack of consideration for practical usage scenarios. Although the inflatable drying devices can create a drying environment, this is achieved at the expense of portability and ease of use. During travel, users often need a device that not only dries clothes quickly and effectively but also is portable and easily stored. Existing inflatable devices, due to their fixed structures and relatively large size, are unable to meet the users'need for drying clothing at any time and in any place. In particular, when multiple garments need to be dried, the limited functionality of these devices becomes more restrictive, making them unable to cope with diverse usage scenarios. In addition, the storage complexity of these devices also fails to satisfy the modern users'demand for convenience and efficiency, constituting a major drawback in use.

Therefore, there is an urgent need to develop a novel portable travel clothing drying device capable of effectively addressing the deficiencies in the prior art, improving drying efficiency, enhancing portability, and adapting to a wider range of usage scenarios. The novel device should not only have good spatial adaptability, but also be capable of drying multiple garments, ensuring uniform airflow distribution, ensuring easy folding and storage after use, thereby meeting modern users'needs for convenience, efficiency and flexibility.

### SUMMARY

To overcome at least one of the shortcomings in the prior art, an objective of the present disclosure is to provide a portable travel clothing drying device. The device is capable of cooperating with a blower during use, allowing the clothing to be laid flat on a drying surface for direct drying. When not in use, the device can be easily folded or rolled for storage, significantly improving portability and saving space. Furthermore, the device enables simultaneous drying of a plurality of garments, accommodating various travel scenarios and possessing significant practical application value.

To achieve the above objectives, the portable travel clothing drying device of the present disclosure includes a drying portion having a drying surface, the drying portion is provided with a cavity or an airflow channel to facilitate circulation and discharge of airflow. Air outlets are formed on the drying surface and are in fluid communication with the airflow channel. Through rationally designed positions and numbers of the airflow channel and the air outlets, a user can adjust an airflow volume according to actual requirements to achieve efficient drying.

As an optional technical solution, the drying surface of the drying portion is provided with a cover layer for covering the air outlets. The user can flexibly control a number and air discharge range of the air outlets by adjusting an opening state and an opening range, thereby adjusting the drying effect.

As an optional technical solution, the drying portion may be designed in various forms. Specifically, the drying portion may be designed as one of a flat plate body, a bag-like body, a pouch-like body, or a box-like body.

As an optional technical solution, the drying portion is a silicone bag body.

As an optional technical solution, in addition to the drying portion, the device further includes a connecting portion in fluid communication with the airflow channel of the drying portion and configured to be connected to an external blower. The connecting portion has a connecting port for connecting to the external blower.

In a preferred embodiment, the connecting port of the connecting portion is an elastic connecting port with an adjustable aperture diameter.

In a preferred embodiment, the connecting port adopts a band-wrapped structure, where the aperture diameter of the connecting port can be adjusted flexibly by tightening or loosening the band to adapt to connection requirements of different aperture diameters.

As an optional technical solution, a plurality of protrusions are arranged on the drying surface to reduce a contact area between the drying surface and the garment during operation, thereby improving airflow guidance and heat dissipation efficiency.

As an optional technical solution, the drying portion is provided with a timing device, and the timing device is configured to better monitor and control a drying duration.

As an optional technical solution, the drying portion is provided with a temperature sensor having a temperature alarm function.

As an optional technical solution, the drying surface of the drying portion is recessed relative to edges of the drying portion, and a flat concave surface is formed.

Further, in a preferred embodiment, the drying portion is a pouch-like body or a box-like body, the drying portion is provided with an openable portion for placing and removing items.

Further, in a preferred embodiment, the drying portion is a hollow flat plate body, and the airflow channel is formed using the hollow structure.

Further, in a preferred embodiment, when the drying portion is any one of a bag-like, pouch-like, or box-like body, the drying portion includes at least a working layer and a bottom layer. Edges of the working layer and the bottom layer are sealed to form an inner cavity that serves as an airflow channel. The air outlets are formed on the working layer, making an outer surface of the working layer serve as the drying surface. During operation, the inner cavity of the drying portion is injected with cold or hot airflow.

Further, in a preferred embodiment, when the drying portion is a bag-like body or a pouch-like body, the drying portion includes at least a working layer and a bottom layer. An inner cavity between the working layer and the bottom layer are partitioned into a plurality of interconnected sub-cavities by a plurality of partition connection lines. During operation, the sub-cavities are inflated under the action of airflow to form protrusions. The protrusions reduce a contact area between the drying surface and the garment, thereby improving airflow guidance and heat dissipation efficiency.

Further, in a preferred embodiment, when the drying portion is a bag-like body or a pouch-like body, the drying portion includes at least a working layer and a bottom layer, and the working layer is a waterproof layer.

Further, in a preferred embodiment, the drying portion is a pouch-like body or a bag-like body, and the drying portion is provided with a zippered opening for placing and removing items.

Further, in a preferred embodiment, the drying portion is a box-like body, and the drying portion is provided with a zippered opening or a snap-fit structure for placing and removing items.

Compared with the prior art, the present disclosure has at least one of the following beneficial effects:

1. Improved space utilization: Compared with conventional inflatable designs, present disclosure adopts the flat bag-like structure, which not only reduces the requirement for usage space and allows flexible use in confined areas, greatly enhancing portability and adaptability, especially suitable for travel and outdoor use.

2. Simultaneous drying of multiple garments: The airflow channel structure and the plurality of sub-cavity design of the present disclosure allow multiple garments to be dried simultaneously, addressing the problem of single-item drying and low efficiency in the prior art, meeting the needs of various scenarios.

3. Enhanced drying uniformity: By providing protrusions on the drying surface and partitioned sub-cavities, the present disclosure improves airflow guidance and heat dissipation efficiency, solving the problem of uneven drying in the prior art, and ensuring uniform heating of garments throughout the drying process.

4. Convenient storage and portability: The present disclosure adopts bag-like and plate-like designs, which allows for easy folding or rolling for storage after use, providing higher portability and easier storage compared with conventional inflatable devices, making it particularly suitable for travel.

5. Increased flexibility and functionality: By providing adjustable air outlets and a diameter-adjustable connecting port, the present disclosure can adapt to the blowers with various diameters and flexibly adjust the drying effect, further improving the versatility and practicality of the device, overcoming the limitation of single functions of the existing devices.

The advantageous effects described above are not exhaustive. Other potential advantages and detailed technical implementations will be further disclosed in the embodiments or other portions of the present disclosure.

### BRIEF DESCRIPTION OF THE DRAWINGS

Various aspects of the present disclosure will be better understood by reading the following detailed description in conjunction with the accompanying drawings. It should be noted that the positions, dimensions, and ranges of various structures shown in the drawings do not necessarily represent their actual positions, dimensions, and ranges. In the accompanying drawings:

FIG. 1 is a schematic structural diagram of Embodiment 1 of the present disclosure.

FIG. 2 is a schematic diagram of an internal structure of Embodiment 1 of the present disclosure.

FIG. 3 is a reference diagram of Embodiment 1 of the present disclosure in a use state.

FIG. 4 is a schematic structural diagram of Embodiment 2 of the present disclosure.

FIG. 5 is a reference diagram of Embodiment 2 of the present disclosure in a use state.

FIG. 6 is a schematic structural diagram of Embodiment 3 of the present disclosure.

FIG. 7 is a schematic structural diagram of Embodiment 4 of the present disclosure.

FIG. 8 is a reference diagram of Embodiment 4 of the present disclosure in a use state.

FIG. 9 is a schematic structural diagram of Embodiment 5 of the present disclosure.

FIG. 10 is a schematic structural diagram of Embodiment 6 of the present disclosure.

FIG. 11 is a schematic structural diagram of Embodiment 7 of the present disclosure.

FIG. 12 is a schematic structural diagram of Embodiment 8 of the present disclosure.

### DESCRIPTION OF EMBODIMENTS

The present disclosure will now be described with reference to the accompanying drawings, in which several embodiments of the present disclosure are illustrated. However, it should be understood that the present disclosure may be presented in many different forms and is not to be limited to the embodiments described below. In fact, the embodiments described below are provided to make the present disclosure more complete and to fully illustrate the scope of protection of the present disclosure to those skilled in the art. It should further be understood that the embodiments disclosed herein may be combined in various ways to provide more additional embodiments.

It should be understood that, throughout all of the drawings, identical reference numerals refer to the same elements. In the drawings, some features may be distorted for clarity of illustration. In the accompanying drawings, for the sake of clarity, the dimensions of some features may be distorted.

It should be understood that the terms used in the specification are intended only to describe particular embodiments and are not intended to limit the present disclosure. Unless otherwise defined, all terms (including technical and scientific terms) used in the specification shall have the meanings commonly understood by those skilled in the art. For the sake of brevity and/or clarity, techniques, methods, and devices known to those of ordinary skill in the art may not be described in detail herein, but should be considered part of the authorized specification.

As used in the specification, the singular forms “a/an,” “the”, and “said” include the plural forms as well. As used herein, the terms “include/comprise,”“including/comprising,” “contain” specify the presence of stated features, but do not preclude the presence of one or more additional features. The term “and/or” used in the specification includes any and all combinations of one or more of the associated listed items.

### Embodiment 1

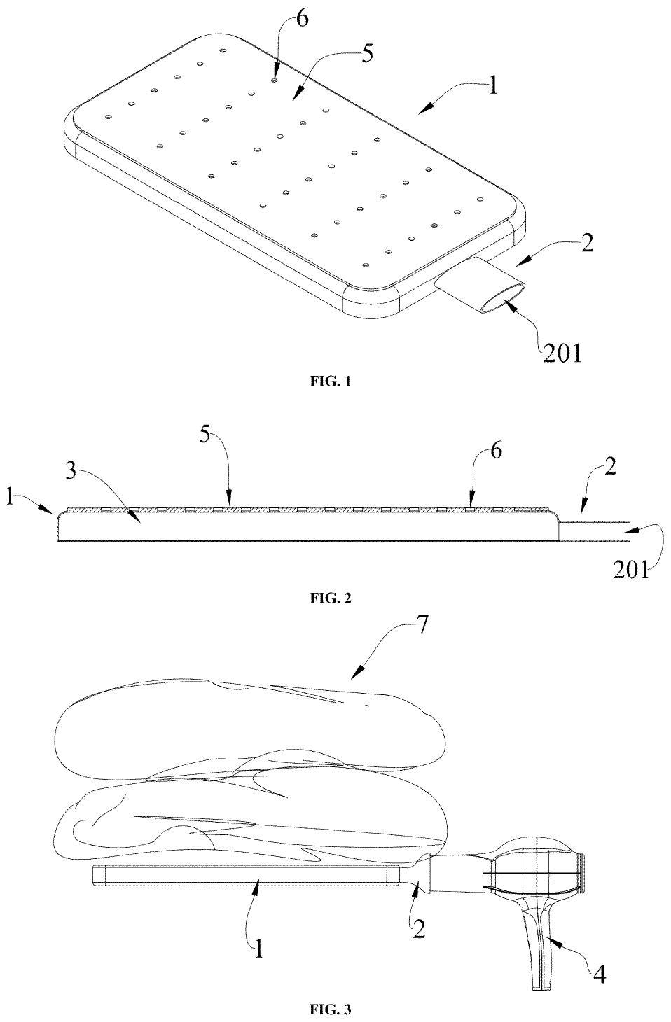

As shown in FIGS. 1-3, this embodiment provides a portable travel clothing drying device, which is intended to provide a traveler with an efficient and convenient clothing drying solution in various environments.

A core structure of the device includes a drying portion 1 and a connecting portion 2. The drying portion 1 is configured to perform a garment drying function, and a connecting portion 2 is configured to connect with an external blower 4, and the external blower 4 supplies continuous airflow to maintain the effectiveness of an entire drying process. An interior of the drying portion 1 is precisely designed with one or more airflow channels 3 to guide the airflow generated by the external blower 4 into an interior of the device and distribute the airflow evenly onto a surface of a garment 7 to ensure efficient drying.

The drying portion 1 is designed with a hollow flat plate structure. In some embodiments, as shown in FIGS. 1-3, the airflow channel 3 is formed in the entire plate through a hollow design. This hollow design not only reduces an overall weight of the device, making the device more portable. Furthermore, the formation of the airflow channel 3 enables the airflow to flow along a specific path in the drying portion 1. The airflow channel 3 introduces the airflow through the connecting portion 2 that is connected to the external blower 4, such that the airflow can be evenly distributed along the specific path after entering the airflow channel 3.

A drying surface 5 is disposed on one side of the drying portion 1, and is configured to be directly communicated with the airflow channel 3. A plurality of air outlets 6 are evenly distributed on the drying surface 5, and the air outlets 6 are in fluid communication with the internal airflow channel 3, such that the airflow is discharged from the airflow channel 3 through the air outlets 6. The airflow flows through the air outlets 6 at a predetermined velocity and temperature and acts uniformly on the surface of the garment 7, thereby achieving efficient drying. In addition, the design of the drying surface 5 also takes into account the uniform distribution of airflow, such that when the airflow flows across the surface of the garment 7, a larger coverage area is achieved, thereby avoiding uneven local drying.

The connecting portion 2 plays a critical role by tightly connecting the external blower 4 with the airflow channel 3 of the drying portion 1, thereby ensuring that the airflow can be stably guided from the external blower 4 into the airflow channel 3. In practical use, the external blower 4 is aligned and connected with the connecting portion 2 by a user. The airflow generated by the external blower 4 continuously enters the airflow channel 3 through the connecting portion 2, the airflow flows smoothly in the airflow channel 3, and is discharged through the air outlets 6 to act on the surface of the garment 7. Since the connecting portion 2 is designed with an adjustable interface with the external blower 4, the device can adapt to the external blower of varying specifications, ensuring flexibility of use in various scenarios.

### Embodiment 2

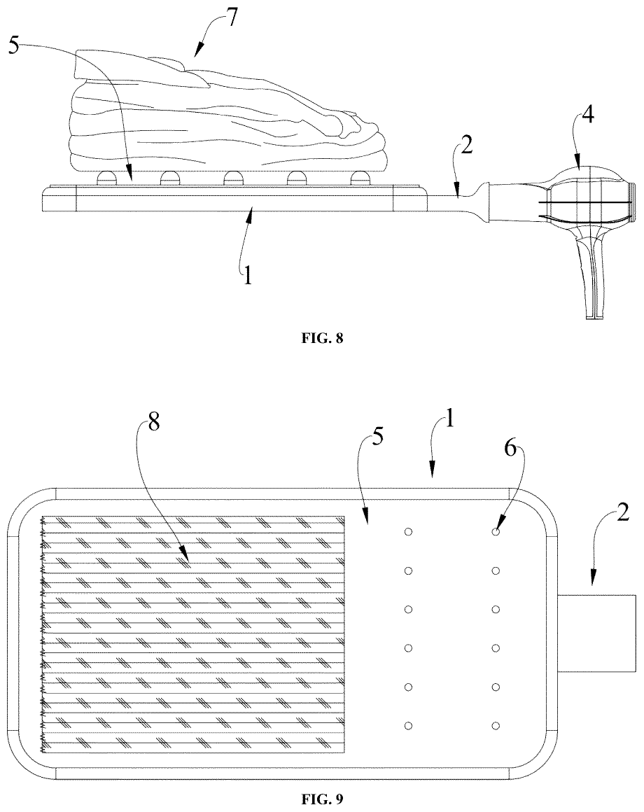

To further improve drying efficiency, as shown in FIGS. 7-8, the drying surface 5 is provided with protrusions. The primary purpose of this design is to reduce a direct contact area between the drying surface 5 and the garment 7, thereby optimizing airflow circulation and heat dissipation during the drying process. Specifically, a surface of the drying surface 5 is not completely flat, but rather is provided with a plurality of uniformly distributed protrusions. The protrusions support the garment 7, preventing the garment 7 from completely adhering to the drying surface 5, thereby creating a space for air circulation.

When the airflow generated by the external blower 4 is introduced into the device through the airflow channel 3 and discharged from the air outlets 6 of the drying surface 5, the protrusions form a plurality of tiny gaps between the drying surface 5 and the garment 7, allowing the air to flow more freely through the gaps. This design effectively reduces the direct contact area between the garment 7 and the drying surface 5, preventing the garment from sticking to the drying surface and obstructing the airflow, and enabling the airflow to be more evenly distributed across the surface of the garment 7.

The gaps for air circulation not only enhance the airflow guidance but also improve the heat transfer efficiency during the drying process. Since the airflow can smoothly flow through the gaps between the garment 7 and the drying surface 5, the heat dissipation effect is significantly improved throughout the drying process. As the airflow flows across the surface of the garment, moisture can be removed rapidly, thereby shortening drying time while avoiding uneven drying caused by concentrated airflow in localized areas.

In addition, the protrusions also provide a certain degree of support for the garments, helping the garment maintain its shape and preventing excessive wrinkling caused by the hot airflow during the drying process. This design not only improves the uniformity of drying but also ensures that the garments become smoother after drying, reducing the need for subsequent handling. Therefore, by optimizing an airflow path, reducing the contact area between the garment and the drying surface, and increasing air circulation, the protrusions improve both drying efficiency and drying performance, demonstrating the design advantages of the portable garment travel drying device.

In a further implementation mode, a timing device and a temperature sensor are integrated in the device, thereby providing an intelligent operational experience, and ensuring both the safety and efficiency of the drying process.

As shown in FIG. 3, when the external blower 4 operates, the airflow enters the airflow channel 3 of the drying portion 1 through the connecting portion 2, and then is evenly discharged through the air outlets 6, and directly acts on the surface of the garment 7, thereby accelerating moisture evaporation and achieving rapid drying.

### Embodiment 3

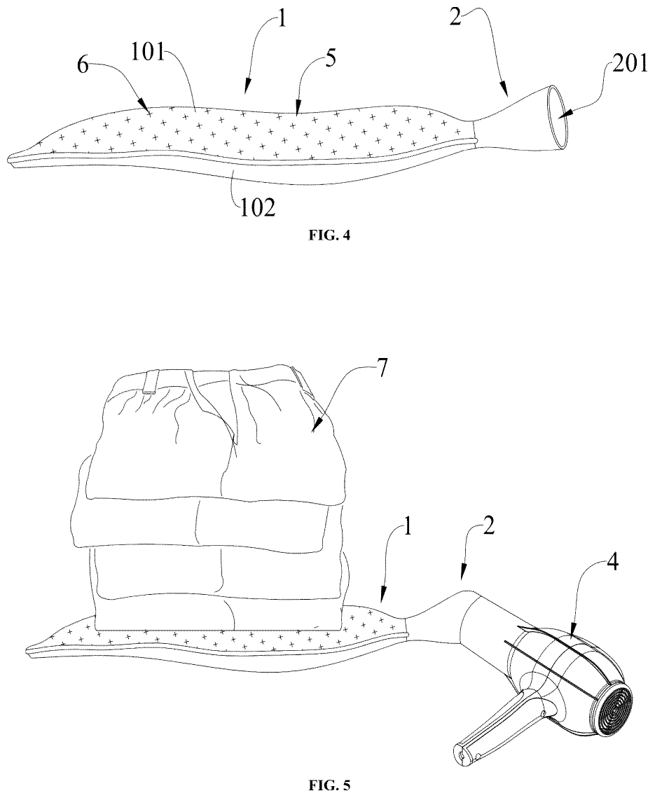

As shown in FIGS. 4-5, in another embodiment, the drying portion 1 is configured as a bag-like body structure, including a working layer 101 and a bottom layer 102. The key of this design is that the drying portion is configured as a hollow cavity using two separate layers to guide the airflow for drying operation.

The working layer 101 serves as an outer functional layer of the entire device, and is in direct contact with the garment and is also a region where the air outlets 6 are located. Edges of the working layer 101 and the bottom layer 102 are sealed, ensuring a firm connection between the two layers at their edges, and thus forming an enclosed inner cavity between the two layers. The inner cavity is designed as the airflow channel. When the airflow generated by the external blower enters the inner cavity, it flows along a specific path within the enclosed airflow channel. A structural design of the airflow channel ensures uniform distribution of the airflow within the inner cavity, preventing airflow concentration or dissipation.

The air outlets 6 are formed on an outer surface of the working layer 101, that is, on the drying surface 5. The air outlets 6 are directly connected to the inner cavity. When the airflow enters the inner cavity, it is discharged through the air outlets 6 and directly acts on the outer surface of the working layer 101, thereby drying the garment placed on the drying surface 5. Since one of the design purposes of the working layer 101 is to guide the airflow from the inner cavity to the surface of the garment, the distribution of the air outlets 6 is carefully designed to ensure that the airflow uniformly covers the entire drying surface 5. Through the design of the air outlets, the airflow can be effectively discharged, and the problem of excessive strong or weak local airflow during the drying process can be prevented.

As a functional layer of the device, the working layer 101 is required not only to provide airflow discharge and heat dissipation functions but also to have sufficient mechanical strength to withstand the weight of garments. The bottom layer 102 serves as a support layer, primarily enhancing structural stability and ensuring the integrity of the inner cavity, allowing for smooth flow of the airflow within the inner cavity. The enclosed structure formed by the bottom layer 102 and the working layer 101 ensures the controllability of an airflow path, thereby preventing air leakage or loss of control of the airflow.

Another advantage of the bag-like design is its flexibility. Unlike conventional rigid structures, the bag-like body can be easily folded and carried, occupying less space when not in use, making it particularly suitable for portable use scenarios. In addition, the inner cavity provides an independent airflow channel space, such that the airflow is evenly distributed within the inner cavity before being discharged through the air outlets 6 toward the garment, thereby ensuring a stable and consistent drying process.

In specific implementation, the bag-like body may be made of a silicone material. Silicone has excellent heat resistance and flexibility, enabling it to remain stable in high-temperature conditions without deformation, while being easy to fold and carry, thereby meeting the requirements of a portable design. The silicone of the working layer 101 is waterproof, preventing moisture from penetrating the inner cavity, and protecting the internal structure and facilitating cleaning.

### Embodiment 4

As shown in FIG. 10, in one embodiment, the working layer 101 and the bottom layer 102 are connected by partition connection lines, which divide the inner cavity into a plurality of interconnected sub-cavities. Through this design, the airflow entering the inner cavity is distributed across the entire drying surface 5 through the plurality of sub-cavities, rather than flowing through a single channel. The partitioned structure not only contributes to the uniform distribution of airflow, but also provides support for the formation of effective protrusions during the drying process.

When entering the inner cavity through the connecting portion, the airflow generated by the external blower flows into each of the sub-cavities. Under air pressure, the sub-cavities expand, which causes some portions of the working layer to bulge outward, thereby forming a plurality of small bulged structures 103. The bulged structures 103 impart a three-dimensional effect on the drying surface 5, which is not only aesthetic, but also reduces the direct contact area between the drying surface 5 and the garment 7 through the bulged structures 103. As a result, the garment 7 does not fully adhere to the drying surface 5, thereby avoiding tight contact between the garment and the drying surface 5, and providing sufficient space for air circulation.

The bulged structures formed during the expansion of the sub-cavities effectively facilitate air circulation. When the airflow is discharged through the air outlets 6 and directed onto the surface of the garment, the bulged structures allows the airflow to flow freely between the garment and the drying surface 5. The flow not only accelerates moisture evaporation but also enhances uniform heat transfer, preventing uneven drying of the garment caused by insufficient airflow in some regions.

### Embodiment 5

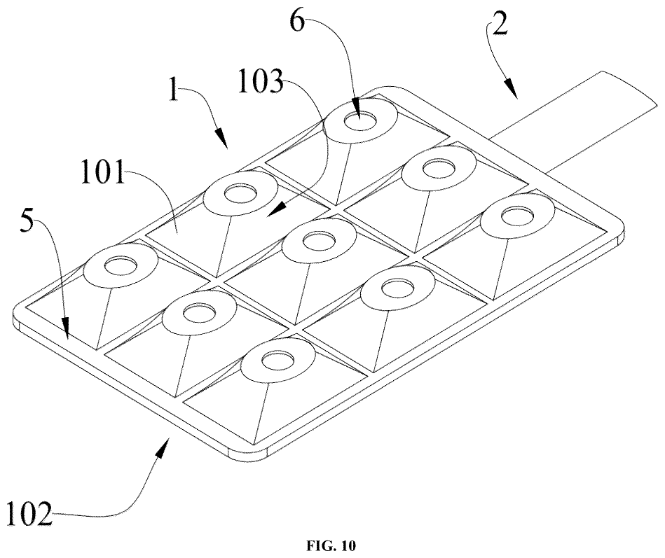

In a further embodiment, as shown in FIG. 9, a cover layer 8 is disposed on the drying surface 5, specifically designed for flexibly adjusting an operating state of the air outlets 6. The cover layer 8 is arranged above the air outlets 6, and the user can manually adjust the open or closed state of the cover layer 8 to control both a degree of opening of the air outlets 6 and a range of exhaust airflow. This design not only improves the flexibility of the device but also provides the user with greater control over airflow, thereby enabling precise adjustments according to different garment types and drying requirements.

The cover layer 8 may be partially or fully opened according to the user's actual needs. By partially opening the cover layer 8, a user may selectively close a portion of the air outlets 6, such that the airflow is concentrated at the air outlets that are not covered, thereby forming a more concentrated airflow. The concentrated airflow mode is particularly suitable for drying small items or scenarios requiring a shorter drying time. By reducing a number of the air outlets 6, the airflow pressure increases accordingly, and speed and temperature of the airflow are concentrated toward a specific region, thereby improving localized drying efficiency.

When the user needs to dry a larger garment or a plurality of garments at the same time, the cover layer 8 can be fully opened to allow airflow to be discharged through all of the air outlets 6. In this case, as the number of air outlets 6 increases, the airflow is more evenly distributed over the entire drying surface 5, covering a larger drying area. As a result, the airflow can act uniformly across the entire surface of the garment, avoiding poor drying performance caused by weak airflow in certain localized regions. This mode is particularly suitable for drying large garments or for simultaneous drying of the plurality of garments.

In addition, the design of the cover layer 8 effectively helps adjust the intensity and concentration of the airflow. By controlling the number of air outlets 6 that are opened, the user can flexibly adjust the distribution of airflow to enable it to better match the drying requirements of different types of garments. For example, a thinner garment may require relatively gentle airflow, while a thicker fabric may require stronger airflow to ensure rapid evaporation of moisture. By adjusting the cover layer 8, the user can select the most suitable airflow distribution and intensity based on the characteristics of different garments, ensuring uniform and efficient drying of the garments.

This flexible control of the air outlets 6 not only improves drying efficiency but also enhances the applicability of the device. Different types and sizes of garments can be accommodated by adjusting the cover layer 8 to meet various drying needs. The user can select either a concentrated airflow mode or a dispersed airflow mode according to the actual usage scenario to achieve optimal drying effect. In addition, this design simplifies user operation by providing a more intuitive adjustment method, making the entire drying process more intelligent and efficient.

### Embodiment 6

As shown in FIG. 11, the drying portion 1 may be configured as a bag-like body to accommodate different usage requirements and environments. The drying portion 1 is a closed container structure with a certain degree of flexibility, similar to a storage bag commonly used during travel. This design is relatively lightweight, convenient for the user to carry, and adaptable to garments of different sizes and shapes, thereby meeting the need for rapid drying during travel.

Specifically, the bag-like drying portion 1 is provided with a zippered opening, usually located at a side or top of the drying portion. The zippered opening facilitates the placement of garments for storage and is suitable for travel portability. Furthermore, garments may also be placed into the drying portion 1 for drying and may be removed therefrom after drying.

More specifically, the zippered opening may adopt a two-way zipper design to enhance the flexibility of opening and closing, allowing the user to select an appropriate direction and range of the opening as needed. The zipper is usually made of high-strength plastic or metal to ensure it can withstand repeated use without wear or breakage, which could affect the service life of the device. To enhance sealing performance, waterproof gaskets or sealing strips may be provided along edges of the zippered opening to prevent airflow leakage through gaps during the drying process, thereby improving drying efficiency.

Size and position of the zippered opening are also carefully designed, such that the user can easily place or remove the garments, while ensuring a tight closure when the zipper is fastened, ensuring that hot or cold airflow can circulate fully within the inner cavity to achieve optimal drying effect.

### Embodiment 7

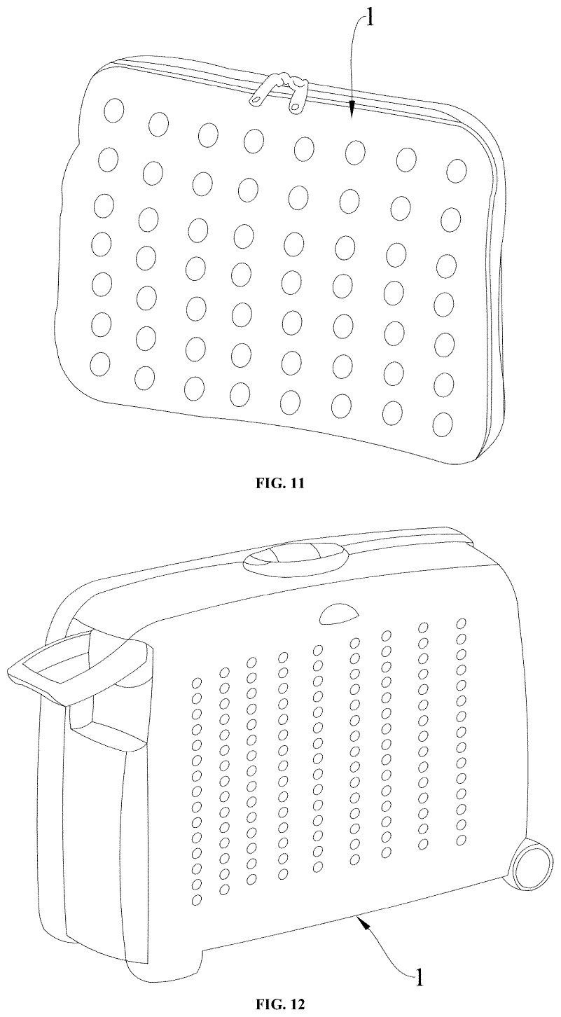

In addition, with reference to FIG. 12, the drying portion 1 may also be configured as a box-like structure. The box-like design provides more stable support and a larger inner cavity space, making it suitable for scenarios that require greater capacity and stability, such as long-distance family travel. The box-like drying portion 1 is provided with an openable and closable opening structure, allowing the user to place or remove the garments via either a zippered opening or a snap-fit structure. The design of zippered opening is similar to that of the bag-like structure, enabling flexible opening and closing while maintaining good sealing performance. The snap-fit structure is suitable for a rigid housing of the box-like body. A plurality of snap-fits are provided to achieve secure closure, ensuring that the opening remains stably closed during use and prevent accidental opening due to vibration or external force.

The snap-fit structure includes symmetrically arranged snap-fits to ensure reliable closure. The user only needs to snap the snap-fits to close the opening, or release the snap-fits to open the box-like body, making operation easy. This snap-fit structure is particularly suitable for applications requiring high sealing performance and can also effectively prevent the garments from falling or being damaged due to accidental opening.

It can be ascertained that, regardless of whether a zippered opening or a snap-fit structure is used, the box-like body maintains good sealing performance when in a closed state, ensuring sufficient circulation of hot or cold airflow within the box, avoiding unnecessary leakage and improving drying efficiency.

In order to ensure stable cooperation with the external blower 4, in the structure shown in FIGS. 1-10, a connecting port 201 of the connecting portion 2 is designed as an elastic structure with an adjustable aperture diameter to accommodate the external blower 4 of various specifications. This elastic design allows the connecting port 201 to automatically adjust its diameter through its inherent elasticity when interfacing with the air outlets of different blower models, thereby achieving better sealing performance and stable connection. The elastic structure automatically adapts to variations in blower outlet sizes, eliminating the need for extensive manual adjustment by the user and making the operation simpler.

In addition, the connecting port 201 may also adopt a band-wrapped structure, where an aperture size is further controlled by adjusting the tightness of a band. The band-wrapped structure includes one or more adjustable bands arranged around an outer periphery of the connecting port 201. By manually tightening or loosening the bands, the user can precisely adjust the aperture size of the connecting port 201, ensuring a tight fit with the air outlets of the external blower 4. This design not only expands the applicability of the connecting port 201 but also ensures a high degree of sealing of the connecting port 201 when connected to the external blower 4, thereby preventing airflow leakage at the interface.

When the air outlet of the external blower 4 is relatively large, the user may loosen the band to enlarge the aperture size of the connecting port 201, so as to accommodate the air outlet of the external blower. Conversely, when the air outlet of the external blower 4 is relatively small, the user may tighten the band to reduce the aperture size of the connecting port 201, ensuring a tight fit with the air outlet of the external blower. This manual adjustment method provides the device with a high degree of adaptability, making it reliably connected to a wide range of blowers, including both small portable hair dryers and larger blowers.

Through the aperture-adjustable design, the connecting portion 2 not only ensures compatibility of the connecting port 201 with the external blower 4 but also effectively prevents airflow leakage at the interface. The tight connection between the connecting port 201 and the air outlet of the external blower ensures that the airflow can smoothly enter the airflow channel 3 in the device, thereby maintaining the efficient operation of the entire drying process. Airflow leakage at the interface not only reduces drying efficiency but could also impair the performance of the blower. The band-wrapped design provides additional adjustment flexibility, allowing the user to quickly adjust the size of the connecting port according to different usage requirements, ensuring that each connection achieves optimal sealing effect.

Therefore, the band-wrapped structure of the connecting portion 2 with the adjustable aperture diameter not only enhances the versatility and portability of the device but also greatly improves the user experience. In practical use, the user can quickly and effectively adjust the connecting port according to the size of the external blower, ensuring a stable connection between the device and the external blower, preventing airflow leakage, and ensuring efficient and reliable drying.

### Embodiment 8

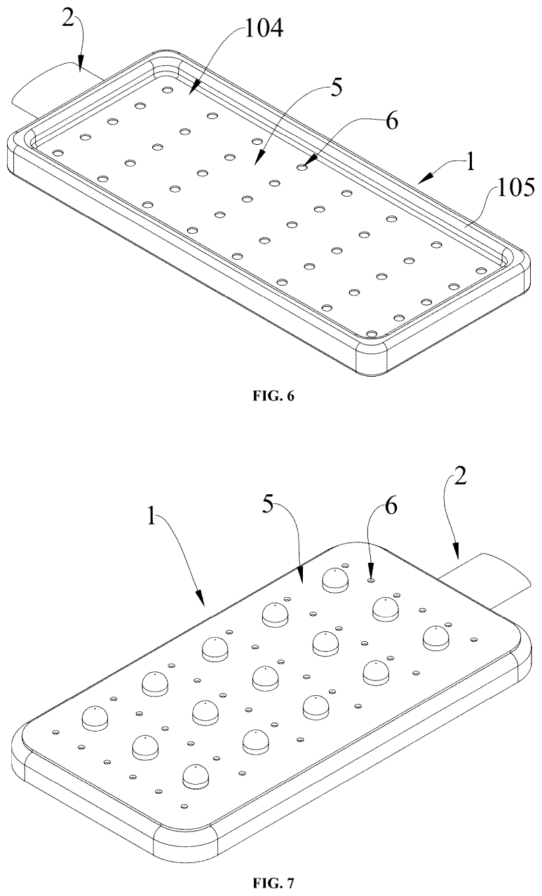

As shown in FIG. 6, the drying surface 5 of the drying portion 1 is configured as a recessed structure relative to edge portions of the drying portion 1, forming a flat concave surface 104. This design aims to optimize airflow distribution and enhance drying performance while providing better stability for the placement of garments. Specifically, edges of the drying portion 1 are slightly raised, while the central drying surface 5 is relatively recessed, forming the uniform concave surface 104. The concave structure 104 effectively guides airflow to be evenly distributed over the surface of the garment.

By concentrating the airflow from the drying portion 1 in the recessed region, the concave surface 104 allows airflow to flow more smoothly and prevents rapid escape of airflow around the edges. This design makes the airflow easily stay on the surface of the garment, improving heat and moisture exchange efficiency and thereby accelerating moisture evaporation. The design is particularly suitable for drying the plurality of garments at the same time; and the concave structure 104 ensures uniform distribution of the airflow across different parts of the garments, avoiding uneven drying in localized areas.

In addition, the concave structure 104 provides more surface contact when placing the garments, preventing the garments from sliding. Compared with the raised edges 105, a central area of the concave surface 104 provides a relatively fixed position, making it easier for the user to lay or stack the garments in the recessed area, ensuring stability of the garments during drying and preventing the garments from shifting caused by airflow impact.

In terms of usage scenarios, the device is suitable for a variety of garment drying needs during travel, business trips, outdoor activities, and other situations. Specifically, when the user stays in a hotel and finds that a garment is not fully dry or needs to be washed but no drying equipment is available, the device can easily solve the problem. The user simply lays the garment flat on the drying surface 5 or places the drying surface 5 over the garment to be dried. Through the connecting portion 2, the device can be connected to a hair dryer in the hotel; since the connecting port 201 is designed as an elastic interface with an adjustable aperture diameter, allowing the user to adjust the aperture diameter according to the air outlet of the hair dryer to ensure a tight connection and prevent airflow leakage. In the case of using the cover layer 8, the user can adjust an opening degree of the cover layer 8 according to drying requirements of different garments, controlling the number and range of the air outlets 6, thereby adjusting the concentration of airflow. Subsequently, the drying time can be set through a timing device to ensure the drying is completed within an appropriate period. After the blower is activated, the airflow is delivered from the blower into the internal airflow channel 3 of the drying portion 1 and uniformly discharged through the air outlets 6, acting on the surface of the garments to accelerate moisture evaporation, thereby achieving rapid and efficient drying.

During outdoor activities, such as camping, hiking, or fieldwork, the user may encounter situations where garments are damp and cannot be dried promptly. Conventional air-drying methods are susceptible to weather and space limitations, and cannot guarantee complete drying of the garments in a short period of time. The lightweight design of the device of the present disclosure is particularly suitable for outdoor use. The silicone material used by the device has excellent heat resistance and flexibility, allowing the device to be easily folded and carried, greatly enhancing portability. The users can utilize a vehicle's ventilation system, a small portable blower, or even natural wind, to introduce airflow into the drying portion 1 through the connecting portion 2. The device requires no additional hanging space and can be used in limited spaces, such as inside a tent or a vehicle, making outdoor drying more flexible and convenient. With the air outlets 6 and the raised structure evenly distributed on the drying surface 5, the airflow can uniformly act on the surface of the garments, promoting moisture evaporation, accelerating the drying process, and ensuring rapid drying of the garment in a short period of time.

Compared with the prior art, the device of the present disclosure demonstrates significant technical advantages in various use scenarios. Conventional portable drying devices often adopt an inflatable design, requiring a relatively large usage space, and the garments must be hung inside the device, making it difficult to implement in small hotel rooms or outdoor environments. In contrast, the device of the present disclosure adopts a flat or bag-like design that can be laid or draped over the garments directly during use without requiring additional hanging space, making it adaptable to a wider range of scenarios. Moreover, conventional devices are often limited by lower drying efficiency, particularly due to uneven airflow, making some garments unable to be effectively dried. The device of the present disclosure features a relatively large drying surface area, combined with the internal airflow channel 3 and the air outlets 6, the device can ensure that the airflow is evenly distributed across the surface of the garments, meeting the need for simultaneous drying of the plurality of garments and significantly improving drying performance.

In terms of portability, the device of the present disclosure adopts an extremely simple design. The device made of soft and durable silicone material allows for easy folding and storage but also enables the user to carry it conveniently, meeting the travelers'needs for lightweight luggage. Conventional inflatable devices have complex structures, large storage volumes, and cumbersome folding and unfolding procedures, making them difficult to carry and significantly limiting their portability during travel. The connecting portion of the device of the present disclosure is designed as an elastic structure with an adjustable aperture diameter to accommodate the dryer or blower of various specifications, greatly enhancing its operational flexibility and applicability.

In practical operation, the device of the present disclosure requires no complex installation or setup steps. Instead, the user simply connects the device to a blower and adjusts the size of the connecting port to ensure a tight connection. When the cover layer 8 is used, an opening state of the cover layer 8 is adjusted according to the drying requirements of the garments to control the number and range of air outlets 6, thereby initiating the drying process.

Therefore, by means of innovative structural design and functional optimization, the portable travel clothing drying device of the present disclosure overcomes the deficiencies of prior art in terms of space occupation, drying efficiency, and portability. In practical use, the device can adapt to various environments, providing an efficient and convenient solution for garment drying. The device has the technical advantages of high space utilization, improved drying efficiency, enhanced portability, simple operation, and high safety, capable of meeting users'diverse garment drying needs during travel, outdoor activities, and daily life, thereby having broad application prospects and market potential.

Although exemplary embodiments of the present disclosure have been described above, those skilled in the art will appreciate that various modifications and changes can be made to the exemplary embodiments without departing from the spirit and scope of the present disclosure. Therefore, all such modifications and changes are intended to be included within the scope of protection of the present disclosure. The present disclosure is defined by the appended claims, and the equivalents of the claims are intended to be included therein.

What is claimed is:

1. A portable travel clothing drying device, comprising: a drying portion having a drying surface, wherein the drying portion is provided with a cavity or an airflow channel to facilitate circulation and discharge of airflow; and
the drying surface has air outlets in fluid communication with the airflow channel, wherein the drying portion is one of a flat plate body, or a bag-like body, or a pouch-like body, or a box-like body.

2. The portable travel clothing drying device according to claim 1, wherein the drying surface of the drying portion is provided with a cover layer for covering the air outlets, and a number of the air outlets and an air discharge range of the air outlets that are actually working are controlled by adjusting an opening state and an opening range of the cover layer.

3. The portable travel clothing drying device according to claim 1, wherein the drying portion is a pouch-like body or a box-like body, and the drying portion is provided with an openable portion for placing and removing items.

4. The portable travel clothing drying device according to claim 1, wherein the drying portion is a hollow flat plate body, and an airflow channel is formed using the hollow structure.

5. The portable travel clothing drying device according to claim 1, wherein an inner cavity of the drying portion is any one of a bag-like body, or a pouch-like body, or a box-like body, and the drying portion comprises at least a working layer and a bottom layer; edges of the working layer and the bottom layer are sealed to form an inner cavity that serves as the airflow channel; the air outlets are formed on the working layer, an outer surface of the working layer serves as the drying surface; and during operation, the inner cavity of the drying portion is injected with cold/hot airflow.

6. The portable travel clothing drying device according to claim 1, wherein the drying portion is a bag-like body or a pouch-like body, the drying portion comprises at least a working layer and a bottom layer, and an inner cavity between the working layer and the bottom layer is partitioned into a plurality of interconnected sub-cavities by a plurality of partition connection lines; and during operation, the sub-cavities are inflated under the action of airflow to form bulged structures.

7. The portable travel clothing drying device according to claim 1, wherein the drying portion is a bag-like body or a pouch-like body, and the drying portion comprises at least a working layer and a bottom layer; and the working layer is a waterproof layer.

8. The portable travel clothing drying device according to claim 1, wherein the drying portion is a pouch-like body or a bag-like body, and the drying portion is provided with a zippered opening for placing and removing items.

9. The portable travel clothing drying device according to claim 1, wherein the drying portion is a box-like body, and the drying portion is provided with a zippered opening or a snap-fit structure for placing and removing items.

10. The portable travel clothing drying device according to claim 1, wherein the drying portion is a silicone bag body.

11. The portable travel clothing drying device according to claim 1, further comprising a connecting portion in fluid communication with the airflow channel of the drying portion and configured to be connected to an external blower, wherein the connecting portion has a connecting port configured to be connected to the external blower.

12. The portable travel clothing drying device according to claim 11, wherein the connecting port of the connecting portion is an elastic connecting port with an adjustable aperture diameter.

13. The portable travel clothing drying device according to claim 12, wherein the connecting port adopts a band-wrapped structure, and the aperture diameter of the connecting port is adjusted flexibly by tightening or loosening the band to adapt to connection requirements of different aperture diameters.

14. The portable travel clothing drying device according to claim 1, wherein a plurality of protrusions are formed on the drying surface to reduce a contact area between the drying surface and the garment during operation, thereby improving airflow guidance and heat dissipation efficiency.

15. The portable travel clothing drying device according to claim 1, wherein the drying portion is provided with a timing device, and the timing device is configured to monitor and control a drying duration.

16. The portable travel clothing drying device according to claim 1, wherein the drying portion is provided with a temperature sensor having a temperature alarm function.

17. The portable travel clothing drying device according to claim 1, wherein the drying surface of the drying portion is recessed relative to edges of the drying portion, and a flat concave surface is formed.
